(19) United States
(12) Patent Application Publication
(10) Pub. No.: US 2004/0028429 A1
(43) Pub. Date: Feb. 12, 2004

(54) Development apparatus and process cartridge using the same

(75) Inventor: Naoki Matsumaru, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/632,914

(22) Filed: Aug. 4, 2003

(30) Foreign Application Priority Data
Aug. 9, 2002 (JP) 2002-233138

(51) Int. Cl. G03G 15/09

(52) U.S. Cl. 399/276

(57) ABSTRACT

To provide a development apparatus capable of, by curbing wear between flange members and a magnet roller and easily keeping accuracy of a clearance t between an inner radius surface of a developing sleeve and a circumferential surface of the magnet roller, generating an even magnetic force around the developing sleeve and further providing a liquid lubricant so as to obtain an image with good quality.

The present invention is the development apparatus having the developing sleeve, flange members fixed at the ends of the developing sleeve and magnet roller placed in the developing sleeve, wherein the ends of the magnet roller are supported concentrically with the developing sleeve by the flange members which are rotatably placed at the ends of the magnet roller, and there is the liquid lubricant on a contact surface between the flange members and the ends of the magnet roller.

### BACKGROUND OF THE INVENTION

1. Field of the Invention

The present invention relates to a development apparatus to be incorporated into an image forming apparatus such as a copying machine or a laser beam printer adopting an electrophotographic process or an electrostatic recording process and a process cartridge using the same.

2. Related Background Art

In the past, there was an image forming apparatus wherein a process cartridge was constituted by incorporating an image bearing member and arbitrary process devices such as a charger, a development apparatus and a cleaning apparatus as a unit into a common housing for functioning as a support member, and the process cartridge was rendered detachable from the image forming apparatus proper so as to improve maintainability and serviceability of the image forming apparatus.

Incidentally, a copying machine has a development apparatus provided thereon for the sake of clearly showing an electrostatic latent image formed on a photosensitive drum which is the image bearing member by means of a developer (toner). As described in Japanese Patent Application Laid-Open No. 2001-175073, a developing roller is provided in the development apparatus, where the toner in the development apparatus is supplied to the photosensitive drum by the action of a magnetic force of the developing roller.

As shown in FIG. 4, the above-mentioned developing roller is comprised of a developing sleeve 1 rotating in a fixed direction, flange members 2 and 3 fixed at both ends of the developing sleeve 1, a magnet roller 4 placed to have a slight clearance t in the developing sleeve 1. The magnet roller 4 has a cylindrical portion 4a and supported portions 4b and 4c comprised of axial portions provided at both ends thereof, where the supported portion 4c is fitted into a supporting opening 9a provided to a supporting portion 9 of the main body of the development apparatus and the supported portion 4b is fitted into the flange member 2 so that a tubular developing sleeve and the cylindrical portion of the magnet roller are concentrically placed. At least one end of the magnet roller 4 has been supported in the developing sleeve 1 by a rolling bearing such as a bearing (not shown) or a sliding bearing 5 such as a resin placed in the above described flange member 2.

In conjunction with requests for higher quality images of the copying machine in recent years, however, it is demanded to keep the magnet roller 4 in the developing sleeve 1 with an accurate clearance t between the developing sleeve and the magnet roller and generate an even magnetic force around the developing sleeve 1. Nevertheless, as for the development apparatus, it was necessary, for the sake of keeping clearance t highly accurate, to improve coaxial accuracy of a circumference and an inner radius of the sliding bearing 5 in addition to improving edge-runout accuracy of the flange member fixed on the developing sleeve, and so there was a problem of a significant load of managing dimensional accuracy.

### SUMMARY OF THE INVENTION

Thus, an object of the present invention is to provide a development apparatus for an image forming apparatus capable of, without using a sliding bearing, keeping an accurate clearance t between an inner radius surface of a developing sleeve and a circumferential surface of a magnet roller so as to provide a function of coping with a request for higher image quality.

Another object of the present invention is to provide a process cartridge using the development apparatus.

The present invention capable of attaining the above objects is the development apparatus having a developing sleeve, flange members fixed at the ends of the developing sleeve and a magnet roller placed in the developing sleeve, wherein the ends of the magnet roller are supported concentrically with the developing sleeve by the flange members which are rotatably placed at the ends of the magnet roller, and there is a liquid lubricant on a contact surface between the flange members and the ends of the magnet roller.

A process cartridge for the image forming apparatus according to the present invention has an image bearing member and a process device for an image forming process for the image bearing member having at least a development device, wherein the process cartridge is detachable from the main body of the image forming apparatus and the above described development device is the development apparatus.

According to the development apparatus of the present invention, supported portions of the magnet roller are supported concentrically with the developing sleeve by the flange members fixed at the ends of the developing sleeve, and the flange members are rotatably placed against the supported portions of the magnet roller. Even in the case of rotation of the flange members for a long time, it is possible, concerning a sliding resistance between the ends of the magnet roller and the flange members, to accurately keep a predetermined spacing between the circumferential surface of the cylindrical portion of the magnet roller and the inner radius surface of the developing sleeve by means of the liquid lubricant existing in a sliding portion so as to provide the development apparatus applicable to development with high image quality. The cases of the flange members rotatably placed against the supported portions of the magnet roller include not only the instances where the flange members rotate without rotating the magnet roller but also the instances where the magnet roller and the flange members rotate in different directions and the instances where the magnet roller and the flange members rotate in the same direction at different speeds.

It is possible, by holding the liquid lubricant at a portion supporting the magnet roller with the flange members, to restrain wear between the flange members and the magnet roller and generate an even magnetic force around the developing sleeve until a user uses up the process cartridge so as to obtain an image with good quality. Furthermore, the flange members serve a bearing function on giving them the liquid lubricant so that there is no need to use a sliding bearing member of the past and it is easy to keep high accuracy of the clearance t between the inner radius surface of the developing sleeve and the circumferential surface of the magnet roller.

### BRIEF DESCRIPTION OF THE DRAWINGS

FIG. 1 is a sectional view of main body of an image forming apparatus;

FIG. 2 is a sectional view of a process cartridge;

FIG. 3 is a sectional view of a developing roller of a development apparatus according to an embodiment of the present invention;

FIG. 4 is a sectional view of the developing roller of the development apparatus in the past; and

FIG. 5 is a sectional view of the development apparatus according to an embodiment of the present invention.

### DETAILED DESCRIPTION OF THE PREFERRED EMBODIMENTS

A liquid lubricant or a solid lubricant may be used as a lubricant to be supplied to a supported portion of a magnet roller and a supporting portion of flanges supporting it. As for the liquid lubricant, any one selected from silicone oils and mineral oils may preferably be used.

As for a material of flange members for supporting the supported portion of the magnet roller, it may be any material capable of obtaining the effects aimed at by using the liquid lubricant according to the present invention, and so a nonmagnetic material of aluminum or stainless steel is preferably used.

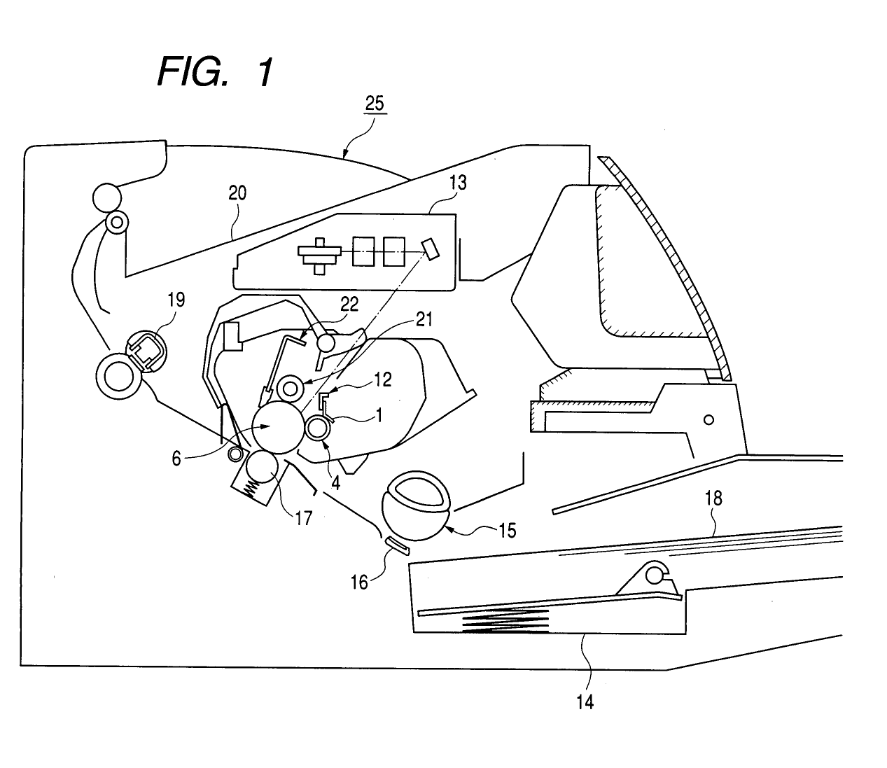

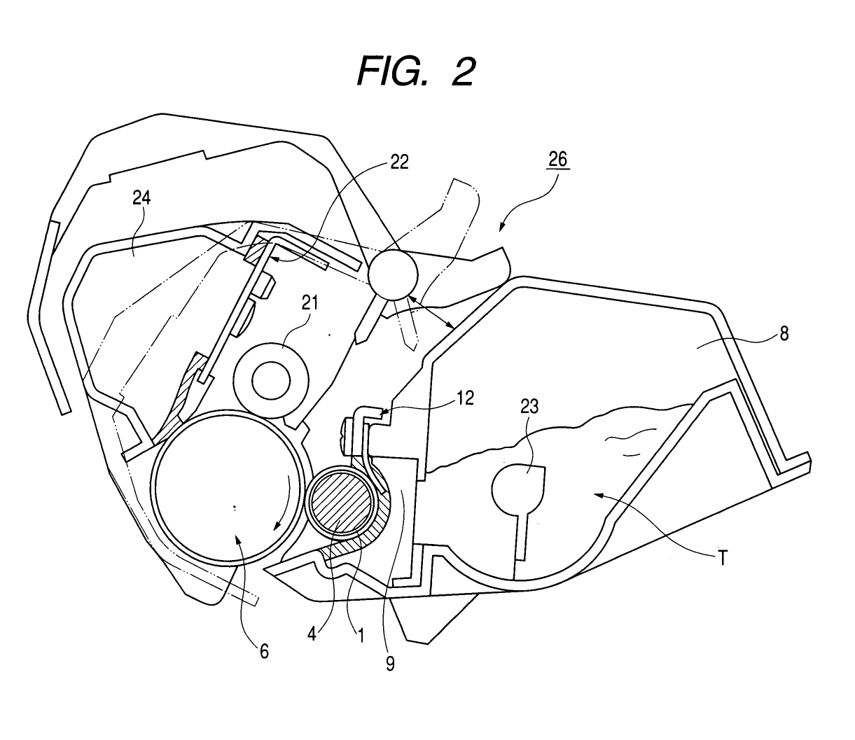

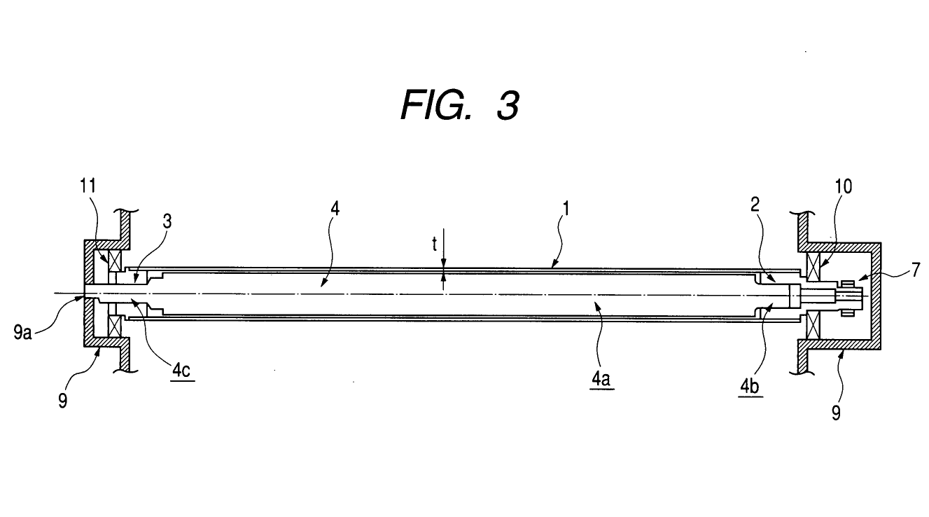

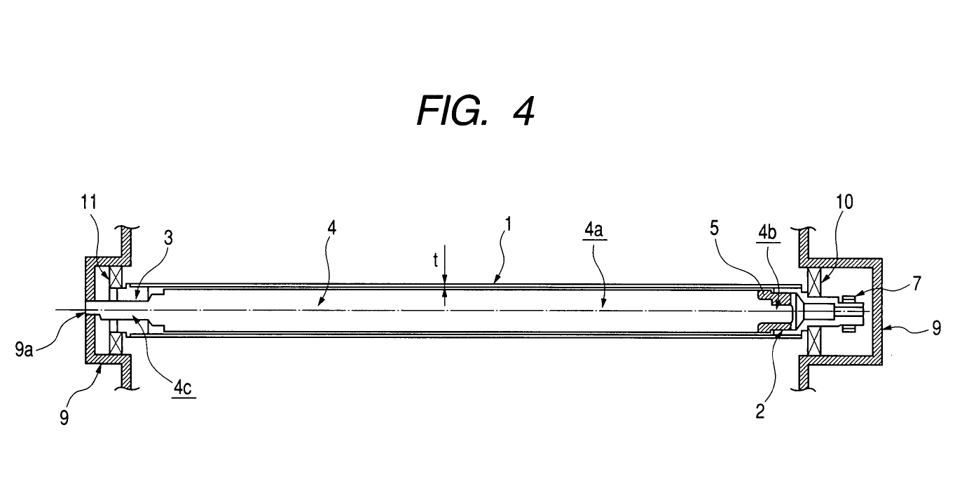

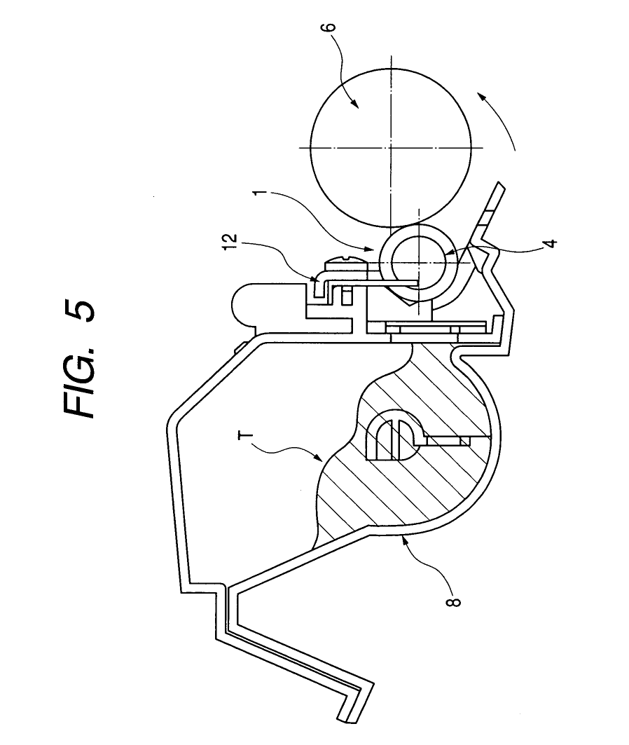

Hereafter, a development apparatus of the present invention will be described based on the attached drawings. FIG. 1 is a sectional view of main body of an image forming apparatus, FIG. 2 is a sectional view of a process cartridge, FIG. 3 is a sectional view of the vicinity of a developing roller of a development apparatus according to an embodiment of the present invention, FIG. 4 is a sectional view of the vicinity of the developing roller of the development apparatus in the past, and FIG. 5 is a sectional view of an example of the development apparatus according to the present invention.

(Electrophotographic Image Forming Apparatus Main Body)

First, a configuration of an electrophotographic image forming apparatus main body 25 will be described according to its operation by using FIG. 1.

Information light based on image information is emitted to an image bearing member 6 in a drum shape from an optical system 13, and an electrostatic latent image is formed on the image bearing member so as to form a developer (toner) image by developing using this electrostatic latent image. And in synchronization with formation of this toner image, a recording medium (recording paper, OHP sheet, etc.) is separated and fed sheet by sheet from a cassette 14 in the apparatus main body by a pickup roller 15 and a pressure contacting member 16 pressure-contacted thereto, and is conveyed by a conveying device comprised of a conveying roller (not shown) and a registration roller (not shown). The above described toner image created on a photosensitive drum 6 is transferred to a recording medium 18 by applying a voltage to a transfer roller 17 as a transfer device, and the recording medium is carried to a fixing device 19 to have the above described toner image fixed on the recording medium by applying heat and pressure so as to carry the recording medium to a discharge portion 20.

(Process Cartridge)

Next, a process cartridge 26 will be described by using FIG. 2.

As shown in FIG. 2, the process cartridge 26 according to this embodiment has a charging apparatus 21, a development apparatus 9 for accommodating the toner and a cleaning apparatus 22 placed around the photosensitive drum 6 which is the image bearing member, and is constituted as a unit by incorporating them as one into a frame so that it is detachable from the electrophotographic image forming apparatus main body in FIG. 1. As shown in FIG. 2, it rotates the image bearing member 6 which is an electrophotographic photosensitive member having a photosensitive layer in the direction of the arrow, and applies the voltage to the charging apparatus 21 which is a charging device to uniformly charge a surface of the image bearing member 6 so that the charged image bearing member is exposed to form a latent image which will be developed by a development device 9. The development device 9 feeds the developer (toner) in a developer storage portion 8 with a rotatable developer agitation member 23, and carries the toner by rotating a developing sleeve 1 which is a developer bearing member containing a magnet roller 4. Here, the above described magnet roller has a plurality of magnetic poles, and is placed in the developing sleeve 1 of which both ends are closed by flange members 2 and 3 (hereafter, the above configuration (the developing sleeve, magnet roller and flange members) will be referred to as a developing roller). The developing sleeve 1 is rotatably supported by a development apparatus 9 (refer to FIG. 3), and one end of the magnet roller 4 is fixed on the development apparatus 9.

The toner given a triboelectric charge by a developing blade 12 is formed on the surface of the developing sleeve 1, and the toner is moved to the image bearing member 6 according to the above described latent image so as to form the toner image and transfer it to a transfer material. After transferring it to the transfer material, the toner remaining on the image bearing member is scraped off by the cleaning apparatus 22 and removed to a waste toner storage portion 24.

The process cartridge according to the present invention has the image bearing member and process devices, wherein the process devices may be comprised of at least the development apparatus and may further have one or more of the devices, as required, for performing the processes used for image formation such as the cleaning device and charging device as described above.

(Description of the Development Apparatus)

Next, the development apparatus according to the present invention will be described by using FIGS. 3 and 5.

As shown in FIG. 5, the development apparatus according to an embodiment of the present invention is placed upstream of the photosensitive drum 6 which is the image bearing member for rotating in the direction of the arrow shown in the drawing. The development apparatus is comprised of the developing roller for supplying a toner T which is the developer to the photosensitive drum 6, the developing blade 12 held in the vicinity of the developing roller for regulating film thickness of the toner T, and a development apparatus main body for holding the developing blade 12 and the above described developing roller, where a hopper portion 8 for storing the toner T is formed on the development apparatus main body. As the toner T accommodated in the development apparatus 9 is a magnetic toner, it is easily held in the vicinity of the developing sleeve 1 by a magnetic force of the magnet roller 4. The toner T held in the vicinity of the developing sleeve 1 by the action of the magnetic pole of the magnet roller 4 moves toward the developing blade 12 in conjunction with rotation of the developing sleeve 1. However, it is directed toward the photosensitive drum 6 in a state in which its film thickness is regulated to be thin by the action of the developing blade 12 and the magnetic pole of the magnet roller 4. And the toner T on the developing sleeve 1 forms a magnetic brush by the action of the magnetic pole of the magnet roller 4, and develops the electrostatic latent image formed on the photosensitive drum 6 so as to clearly show it as the toner image.

(Concrete Configuration of the Developing Roller in reference to FIG. 3)

Here, a description will be given as to a concrete configuration of the developing roller and how it is mounted on the main body of the development apparatus. The developing sleeve 1 is comprised of a nonmagnetic material such as aluminum or stainless steel, and both ends thereof are closed by the flange members 2 and 3 and are rotatably supported by the development apparatus 9 via bearing members 10 and 11. Both ends of the developing sleeve 1 have the flanges 2 and 3 fixed on the ends thereof by means of adhesion, injection or caulking. The flange 2 has a drive gear 7 for conveying the rotation to the developing sleeve 1 bound at the end thereof. And if the drive gear 7 is rotated by obtaining a driving force from an unshown photosensitive drum gear, the developing sleeve 1 rotates at a fixed speed.

The magnet roller 4 is formed as one, by extrusion molding for instance, like a solid roller by using the material wherein magnetic material powder is bound by a synthetic resin binder. The magnet roller may be the one having a magnetic area and an axial portion molded as one as shown or having them built as separate members.

The magnet roller is comprised of a cylindrical portion 4a which is positively magnetized and supported portions 4b and 4c at both ends thereof. And the end 4b of the magnet roller 4 is supported by the inner radius of the flange 2 of the developing sleeve 1. Here, the flange member 2 is comprised of the nonmagnetic material such as aluminum or stainless steel. The sliding portions of the flange member 2 and the magnet roller 4 have the liquid lubricant such as a silicone oil, a mineral oil, a fluorine oil, a spindle oil, a machine oil or the like applied thereto. The lubricant is applied to the supported portion 4b of the magnet roller 4 before inserting the magnet roller 4 into the developing sleeve 1.

The other end 4c of the magnet roller 4 is supported by being fitted into a supporting opening 9a of the supporting portion of the main body of the development apparatus. The other end 4c of the magnet roller 4 may be supported by a flange member 3 instead of being supported by the supporting opening 9a.

As described above, the magnet roller 4 is directly supported by the inner radius of the flange 2 of the developing sleeve 1, and so it does not need other members like a sliding bearing 5 made of resin and a rolling bearing such as a bearing (not shown) as in the past so as to reduce the cost. And it is also possible to define the clearance t between the magnet roller 4 and the developing sleeve 1 by the spacing between them in the supporting portion of the flange member 2 supporting the supported portion 4b of the magnet roller so as to keep it accurately constant based on fitting accuracy among the members. For this reason, the magnetic force of the magnet roller 4 is evenly exerted on the developing sleeve 1, and a proper image with good quality is subsequently formed. As the wear of the magnet roller 4 and the flange member 2 is restrained by the action of the liquid lubricant or solid lubricant, it is possible to keep a stable image formed until the user uses up the process cartridge.

Embodiment

The magnet roller of the process cartridge of a laser beam printer (product name: LBP Laser Jet1200, Hewlett-Packard Company) is changed to the magnet roller with no sliding bearing member shown in FIG. 3 so that it is converted to be directly supported by a sleeve flange and 10 mmg of the liquid lubricant is applied to a sliding surface between the end of the magnet roller portion and the flange member 2 by using a dispenser. In comparison, Teflon grease is applied on the same conditions as the liquid lubricant. The process cartridge thus converted is used to print 3,000 sheets so as to evaluate them by showing the image at an early stage, at an intermediate stage and at a later stage. The results thereof are shown in Table 1.

TABLE 1

| | Enduring | Intermediate | Later image | Magnet roller |
|---|---|---|---|---|
| Applied | early | image | 2000th | wear at the |
| lubricant | image | 100th sheet | sheet | 2000th sheet |
| Mineral oil | A | A | A | AA |
| (Note 1) | | | | |
| Silicone oil | A | A | A | AA |
| (Note 2) | | | | |
| Teflon grease | A | B | C | D |
| (Note 3) | | | | |

(Note 1)
Product name: Shell Tellus #68 (Manufactured by Showa Shell Sekiyu K.K.)
(Note 2)
Product name: Silicone Oil SH200 (Manufactured by Dow Corning Toray Silicone Co., Ltd.)
(Note 3)
Product name: MOLYKOTE EM-50L (Manufactured by Nippon Dow Corning Asia Japan Co., Ltd.)
A: There is no unevenness in concentration of the toner image occurring in accordance with a cycle of the developing sleeve.
AA: There is no wear on the surface of the end of the magnet roller portion due to friction with the flange member 2.
B: There is the unevenness in concentration of the toner image occurring in accordance with the cycle of the developing sleeve.
C: There is the unevenness in concentration of the toner image occurring in accordance with the cycle of the developing sleeve. There is also a frictional sound between the end of the magnet roller portion and the flange member 2.
D: The surface of the end of the magnet roller portion wears 0.1 mm or more due to the friction with the flange member 2.

From the results in Table 1, it is confirmed that, in the case where the liquid lubricant is applied to the magnet roller portion, the wear of the magnet roller can be restrained through endurance, and the clearance t between the magnet roller and the sleeve flange is accurately kept because the magnet roller is directly supported by the sleeve flange so that the image with good quality is obtained through the endurance.

In the case where the grease is applied, the image with good quality is obtained. If the endurance is continued, however, the wear of the magnet roller portion proceeds and a harmful effect on the image is seen from the intermediate stage of the endurance.

What is claimed is:

1. A development apparatus having a developing sleeve, flange members fixed at the ends of the developing sleeve and a magnet roller placed in the developing sleeve, wherein the ends of the magnet roller are supported concentrically with the developing sleeve by the flange members which are rotatably placed at the ends of the magnet roller, and there is a liquid lubricant on a contact surface between the flange members and the ends of the magnet roller.

2. The development apparatus according to claim 1, wherein said liquid lubricant is a silicone oil.

3. The development apparatus according to claim 1, wherein said liquid lubricant is a mineral oil.

4. The development apparatus according to claim 1, wherein said flange members are comprised of an aluminum material.

5. The development apparatus according to claim 1, wherein said flange members are comprised of a stainless steel material.

6. The development apparatus according to claim 1, wherein said magnet roller is formed as one by using the material in which magnetic material powder is bound by a synthetic resin binder.

7. The development apparatus according to claim 1, wherein there are also the flange members fixed at the opposite ends to the ends of the developing sleeve on which said flange members are fixed.

8. A process cartridge having an image bearing member and at least a development device and detachable from main body of an image forming apparatus,
wherein said development device has a developing sleeve, flange members fixed at the ends of the developing sleeve and a magnet roller placed in the developing sleeve, the ends of the magnet roller are supported concentrically with the developing sleeve by the flange members which are rotatably placed at the ends of the magnet roller, and there is a liquid lubricant on a contact surface between the flange members and the ends of the magnet roller.
